(19) United States
(12) Patent Application Publication
(10) Pub. No.: US 2026/0370119 A1
(43) Pub. Date: Nov. 19, 2026

(54) PROCESSOR CHIP MULTI-PATH VOLTAGE REGULATION

(71) Applicant: INTERNATIONAL BUSINESS MACHINES CORPORATION, ARMONK, NY (US)

(72) Inventors: WILLIAM V. HUOTT, HOLMES, NY (US); JUSTIN HENSPETER, GEORGETOWN, TX (US); MICHAEL SPERLING, POUGHKEEPSIE, NY (US); SUNGJUN CHUN, POUGHKEEPSIE, NY (US); LUKE L. JENKINS, POUGHKEEPSIE, NY (US)

(21) Appl. No.: 18/638,774

(22) Filed: Apr. 18, 2024

(51) Int. Cl. H02M 1/00; H02M 3/07; H02M 3/158

(52) U.S. Cl. CPC H02M 1/0045; H02M 1/007; H02M 1/0095; H02M 3/07; H02M 3/158

(57) ABSTRACT

Processor chip multi-path voltage regulation includes receiving, by a multi-path voltage regulator having a plurality of voltage regulation paths, an input voltage. A control unit controls the multi-path voltage regulator, including selecting one of the voltage regulation paths. The selected voltage regulation path regulates the input voltage to generate a regulated output voltage for a processor core.

### BACKGROUND

The present disclosure relates to methods, apparatus, and products for processor chip multi-path voltage regulation.

### SUMMARY

According to embodiments of the present disclosure, various methods, apparatus and products for processor chip multi-path voltage regulation are described herein. In some aspects, processor chip multi-path voltage regulation includes receiving, by a multi-path voltage regulator having a plurality of voltage regulation paths, an input voltage. A control unit controls the multi-path voltage regulator, including selecting one of the voltage regulation paths. The selected voltage regulation path regulates the input voltage to generate a regulated output voltage for a processor core.

### BRIEF DESCRIPTION OF THE DRAWINGS

FIG. 1 sets forth an example computing environment according to aspects of the present disclosure.

FIG. 2 sets forth example processing circuitry according to aspects of the present disclosure.

FIG. 3 sets forth an example multi-path voltage regulator according to aspects of the present disclosure.

FIG. 4 sets forth another example multi-path voltage regulator according to further aspects of the present disclosure.

FIG. 5 sets forth a flowchart of an example method for processor chip multi-path voltage regulation according to aspects of the present disclosure.

### DETAILED DESCRIPTION

In general, a voltage regulator is a circuit that is designed to maintain a constant output voltage level as operating conditions change over time. That is, the voltage regulator may be an electronic device or system designed to receive an input voltage and automatically maintain a constant voltage level on one or more output terminals. Depending on the design, a voltage regulator can be used to regulate one or more alternating current (AC) or direct current (DC) voltages. Voltage regulators can be included in electronic devices such as, for example, computer power supplies where they can be used to stabilize DC voltages used to supply power to electronic components such as processor(s), memory devices, and other types of integrated circuits (ICs).

There are several types of voltage regulators such as, for example, switching regulators, linear regulators, and cascaded regulators that may include both switching and linear regulators in a cascaded architecture. One particular type of linear regulator is a low dropout (LDO) regulator. An LDO regulator is a DC linear voltage regulator that may regulate the output voltage even when the supply voltage is close to the output voltage. That is, the LDO regulator may maintain voltage regulation with small differences between supply voltage and load voltage. Another type of voltage regulator is a buck switching regulator (e.g., a step-down regulator circuit). The buck switching regulator is a type of switch mode power supply circuit designed to efficiently reduce DC voltage from a higher voltage to a lower voltage. Another type of regulator, which is a switched capacitor regulator, may provide high efficiency voltage regulation for integer ratios (e.g., 2:1) and enable high voltage power delivery to the chip on which they reside.

In computer system power delivery, there may be a large step down in voltage from a global power supply down to each individual processor chip/chiplet. It may also be desirable to have per chiplet voltage regulation to minimize power consumption and maximize performance depending on the electrical needs, workload, and silicon process speed/tolerances of each chiplet. Voltage regulator efficiency will vary non-linearly depending on input versus output voltage and current load of each chiplet’s regulator. It may be desirable to have a common high Vin voltage (for lower current) to each chiplet’s local voltage regulator with efficient voltage stepdown and regulation to each chiplet. Creating the most efficient chiplet local stepdown voltage regulator that can fit within current packaging limitations considering embedded passive device requirements may be an important goal.

Some examples disclosed herein are directed to a multi-path voltage regulator (MPVR) that can dynamically choose the most efficient path for local voltage stepdown regulation considering the Vin to the regulator and the Vout and current load requirements of the chiplet. Switched capacitor voltage stepdown circuits may be efficient for integer fraction step downs of the input voltage, like Vout = ½ Vin, or Vout = 2/3 Vin, or Vout = 1/3 Vin. Linear voltage regulators can be efficient when Vout needs to be close to Vin (Efficiency ~= Vout/Vin). Inductor Buck regulators are efficient for larger step-down ratios where Vout/Vin is too small to be efficiently regulated with linear regulators; however, large step-down ratios may use large inductors and thus benefit from pre-regulation with a fixed (or adjustable) ratio switched capacitor regulator first. When regulating across a potentially large range with respect to Vin, the multi-path voltage regulator dynamically switches paths between combinations of switched capacitor regulation, linear regulation, and buck regulation, and can dynamically choose the most efficient mode (or combined mode) of operation. Some examples of this disclosure are directed to a multi-path voltage regulator that can dynamically choose between: Direct linear regulation, direct buck regulation, and switched capacitor pre-regulation leading to either post linear regulation or post buck regulation. Additionally, the switched capacitor to buck regulation path may take advantage of a more efficient method of dual-voltage input buck regulation by, for example, using both Vin and Vin/2 for feeding the buck inductors when Vin>Vout>Vin/2.

Some examples disclosed herein are directed to a dynamically switchable multi-path voltage regulator that includes switched capacitors, inductive buck regulators, and linear regulators. Some examples provide power path optimization based on the path switching and modes of operation including a dual voltage buck mode than can be utilized from Vin and a switched capacitor regulator output. Some examples include control circuitry that dynamically understands the highest efficiency operating point and path while controlling operation to stay at that point.

Some examples disclosed herein are directed to an apparatus for processor chip multi-path voltage regulation, which includes a processor chip, and a multipath voltage regulator control unit coupled to the processor chip for dynamically switching a plurality of voltage regulation pathways of the processor chip and monitoring the voltage in and voltage out requirements of the processor chip. The apparatus further includes one or more linear regulators coupled to the multipath voltage regulator control unit; an inductor buck regulator coupled to the multipath voltage regulator control unit; and a switched capacitor voltage regulator coupled to the multipath voltage regulator control unit.

Some examples disclosed herein are directed to a method for processor chip multi-path voltage regulation, which includes monitoring, continuously, a voltage in and voltage out of a processor chip, utilizing a multi-path voltage regulator control unit. The method includes calculating a ratio of voltage in to voltage out. The method includes dynamically routing an electric current to a voltage pathway based on the monitoring, wherein the routing is based on the calculated ratio and wherein the voltage pathway comprises one or more of the following voltage regulators: a linear regulator, a buck regulator, and a switched capacitor voltage regulator.

Delivering a large number of independent low voltage/high current processor voltages at a system level may be complicated and costly (e.g., in terms of point of load supplies (POL’s), redundant POL’s and board level power supply copper). Some examples disclosed herein provide highly efficient post regulation from a global input voltage at each chip or chiplet. Some examples provide the ability to selectively operate these on package/on chip voltage regulators in an efficient manner, and provide a vastly simplified system regulation scheme. Some examples include a control unit to dynamically select a type of regulation with the highest efficiency at every point. Some examples provide higher power efficiency at a larger range of output voltage levels. Some examples provide higher power efficiency over a larger regulation range. Some examples disclosed herein save power, cost, physical space, reduce system cooling requirements, simplify mechanical design, and provide many other benefits. Some examples disclosed herein are more efficient than other on-chip regulation approaches that come with system complexity to implement correctly.

An example of the present disclosure is directed to a method for processor chip multi-path voltage regulation, which includes receiving, by a multi-path voltage regulator having a plurality of voltage regulation paths, an input voltage. The method includes controlling, by a control unit, the multi-path voltage regulator, including selecting one of the voltage regulation paths. The method includes regulating, by the selected voltage regulation path, the input voltage to generate a regulated output voltage for a processor core.

Examples of the method include various technical features that yield technical effects that provide various improvements to computer technology. For instance, some examples include the technical features of controlling, by a control unit, the multi-path voltage regulator, including selecting one of the voltage regulation paths; and regulating, by the selected voltage regulation path, the input voltage to generate a regulated output voltage for a processor core. These technical features yield the technical effect of providing efficient post regulation from an input voltage, such as a global input voltage, at each processor core. The control unit may dynamically select a type of regulation with the highest efficiency at every point over a large range of output voltage levels.

In some examples, the method further includes performing, by the control unit, an efficiency analysis to identify a most efficient voltage regulation path from the plurality of voltage regulation paths, wherein selecting one of the voltage regulation paths is performed based on the efficiency analysis. In some examples, the method further includes receiving, by the control unit from the processor core, a command indicating a desired regulator output voltage, wherein selecting one of the voltage regulation paths is performed based on the command indicating the desired regulator output voltage.

In some examples of the method, the plurality of voltage regulation paths includes a first path that includes a linear regulator and no other voltage regulators. In some examples of the method, the plurality of voltage regulation paths includes a second path that includes a combination of a switched capacitor regulator and a linear regulator. In some examples of the method, the plurality of voltage regulation paths includes a third path that includes a combination of the switched capacitor regulator and a buck regulator.

In some examples of the method, the plurality of voltage regulation paths includes a path that includes a dual-voltage buck regulator to receive the input voltage and an intermediate regulated voltage that is generated based on the input voltage. In some examples of the method, the dual-voltage buck regulator is to generate the regulated output voltage for the processor core based on one or both of the input voltage and the intermediate regulated voltage.

In some examples of the method, the plurality of voltage regulation paths includes a path that includes a dual-voltage buck regulator to receive a first intermediate regulated voltage that is generated based on the input voltage and a second intermediate regulated voltage that is generated based on the input voltage, and wherein the dual-voltage buck regulator is to generate the regulated output voltage for the processor core based on one or both of the first intermediate regulated voltage and the second intermediate regulated voltage.

Another example of the present disclosure is directed to an apparatus for processor chip multi-path voltage regulation, which includes a multi-path voltage regulator to receive an input voltage, wherein the multi-path voltage regulator includes a plurality of voltage regulation paths. The apparatus includes a control unit to control the multi-path voltage regulator, including selecting one of the voltage regulation paths, wherein the selected voltage regulation path is to regulate the input voltage to generate a regulated output voltage for a processor core.

Examples of the apparatus include various technical features that yield technical effects that provide various improvements to computer technology. For instance, some examples include the technical features of a multi-path voltage regulator to receive an input voltage, wherein the multi-path voltage regulator includes a plurality of voltage regulation paths; and a control unit to control the multi-path voltage regulator, including selecting one of the voltage regulation paths, wherein the selected voltage regulation path is to regulate the input voltage to generate a regulated output voltage for a processor core. These technical features yield the technical effect of providing efficient post regulation from an input voltage, such as a global input voltage, at each processor core. The control unit may dynamically select a type of regulation with the highest efficiency at every point over a large range of output voltage levels.

In some examples of the apparatus, the control unit is to perform an efficiency analysis to identify a most efficient voltage regulation path from the plurality of voltage regulation paths, and wherein selecting one of the voltage regulation paths is performed based on the efficiency analysis. In some examples of the apparatus, the control unit is to receive from the processor core a command indicating a desired regulator output voltage, and wherein selecting one of the voltage regulation paths is performed based on the command indicating the desired regulator output voltage.

In some examples of the apparatus, the plurality of voltage regulation paths includes a first path that includes a linear regulator and no other voltage regulators. In some examples of the apparatus, the plurality of voltage regulation paths includes a second path that includes a combination of a switched capacitor regulator and a linear regulator. In some examples of the apparatus, the plurality of voltage regulation paths includes a third path that includes a combination of the switched capacitor regulator and a buck regulator.

In some examples of the apparatus, the plurality of voltage regulation paths includes a path that includes a dual-voltage buck regulator to receive the input voltage and an intermediate regulated voltage that is generated based on the input voltage. In some examples of the apparatus, the dual-voltage buck regulator is to generate the regulated output voltage for the processor core based on one or both of the input voltage and the intermediate regulated voltage.

In some examples of the apparatus, the plurality of voltage regulation paths includes a path that includes a dual-voltage buck regulator to receive a first intermediate regulated voltage that is generated based on the input voltage and a second intermediate regulated voltage that is generated based on the input voltage, and wherein the dual-voltage buck regulator is to generate the regulated output voltage for the processor core based on one or both of the first intermediate regulated voltage and the second intermediate regulated voltage.

Another example of the present disclosure is directed to a system for processor chip multi-path voltage regulation, which includes a global voltage regulator to generate a global input voltage. The system includes a processor module coupled to the global voltage regulator. The processor module includes one or more processor cores. The processor module includes one or more multi-path voltage regulators to receive the global input voltage, wherein each of the one or more multi-path voltage regulators includes a plurality of voltage regulation paths. The processor module includes one or more control units to control the one or more multi-path voltage regulators, including selecting, for each of the one or more multi-path voltage regulators, one of the voltage regulation paths, wherein each selected voltage regulation path is to regulate the global input voltage to generate a regulated output voltage for one of the one or more processor cores.

Examples of the system include various technical features that yield technical effects that provide various improvements to computer technology. For instance, some examples include the technical features of a processor module that includes one or more control units to control the one or more multi-path voltage regulators, including selecting, for each of the one or more multi-path voltage regulators, one of the voltage regulation paths, wherein each selected voltage regulation path is to regulate the global input voltage to generate a regulated output voltage for one of the one or more processor cores. These technical features yield the technical effect of providing efficient post regulation from an input voltage, such as a global input voltage, at each processor core. The control unit may dynamically select a type of regulation with the highest efficiency at every point over a large range of output voltage levels.

In some examples of the system, the one or more control units is to perform an efficiency analysis to identify, for each of the one or more multi-path voltage regulators, a most efficient voltage regulation path from the plurality of voltage regulation paths, and wherein selecting one of the voltage regulation paths is performed based on the efficiency analysis.

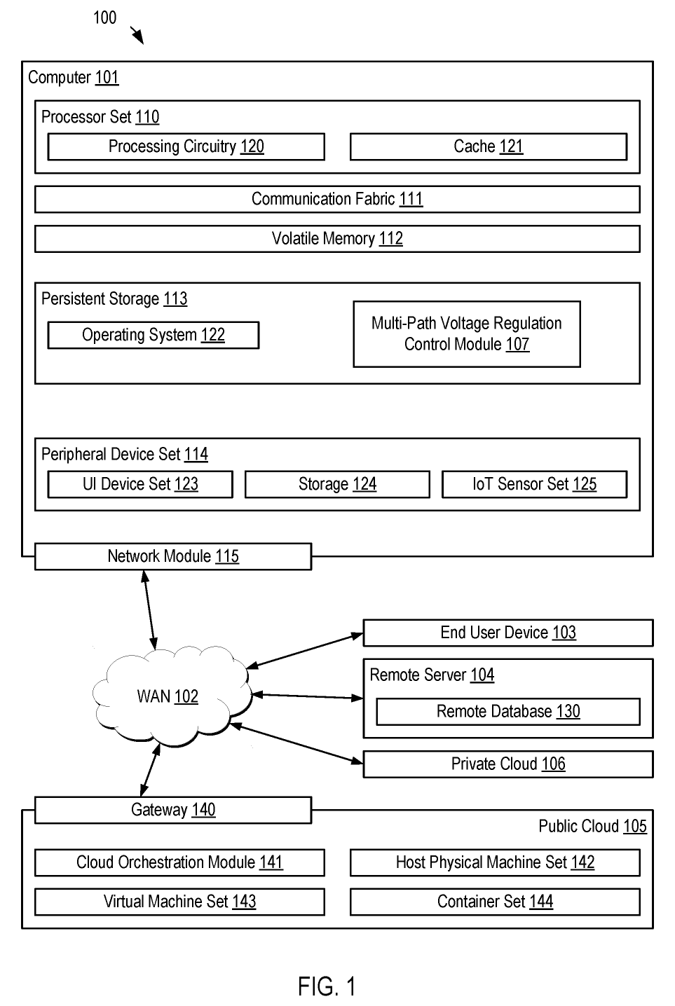

FIG. 1 sets forth an example computing environment 100 according to aspects of the present disclosure. Computing environment 100 contains an example of an environment for the execution of at least some of the computer code involved in performing the various methods described herein, such as multi-path voltage regulation control module 107. Functionality of multi-path voltage regulation control module 107 may be implemented in hardware, software, or a combination of hardware and software, and may be distributed throughout various blocks of computing environment 100, including within processor set 110. In addition to multi-path voltage regulation control module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and multi-path voltage regulation control module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in multi-path voltage regulation control module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in multi-path voltage regulation control module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

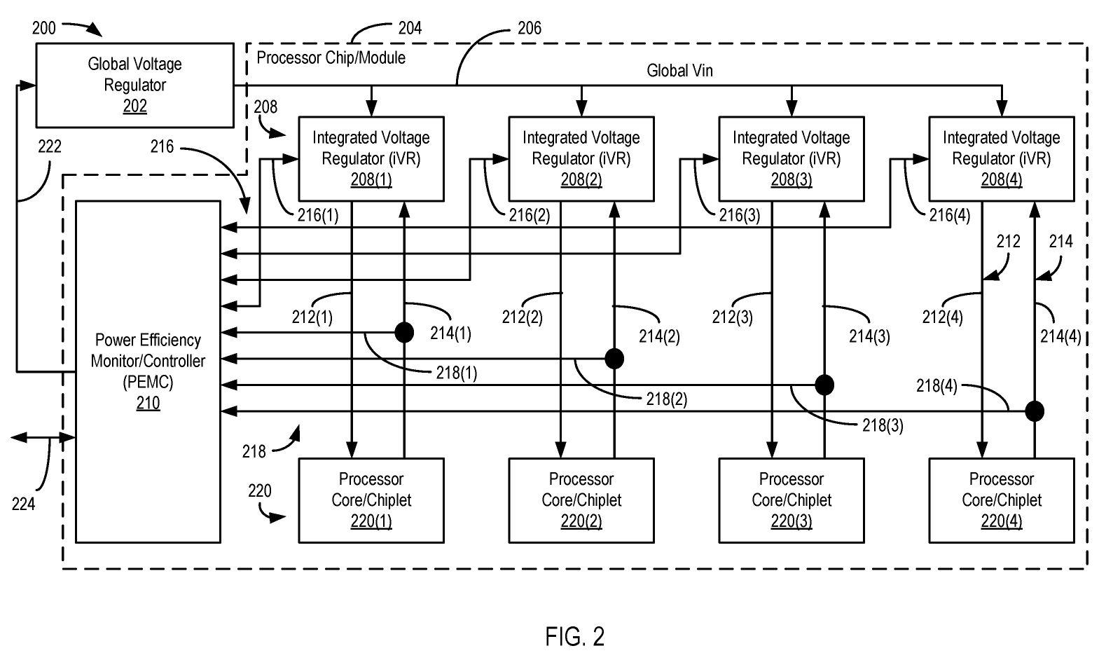

FIG. 2 sets forth example processing circuitry 200 according to aspects of the present disclosure. Processing circuitry 200 is an example of processing circuitry 120 (FIG. 1), and may implement some or all of the functionality of multi-path voltage regulation control module 107. Processing circuitry 200 includes global voltage regulator 202 and processor chip/module 204. In the illustrated example, global voltage regulator 202 is external to the processor chip/module 204. Processor chip/module 204 includes integrated voltage regulators (iVRs) 208(1)-208(4) (collectively referred to as integrated voltage regulators 208), power efficiency monitor/controller (PEMC) 210, and processor cores/chiplets 220(1)-220(4) (collectively referred to as processor cores/chiplets 220). Although four integrated voltage regulators 208 and four processor cores/chiplets 220 are shown in FIG. 2, in other examples, a different number of these elements may be used.

Global voltage regulator 202 outputs a global input voltage, Vin, to each of the integrated voltage regulators 208 via communication link 206. Based on the received global input voltage, Vin, the integrated voltage regulators 208(1)-208(4) output a voltage regulator output voltage, Vout, to processor cores/chiplets 220(1)-220(4), respectively, via respective communication links 212(1)-212(4) (collectively referred to as communication links 212). Processor cores/chiplets 220(1)-220(4) may send a Vout command to integrated voltage regulators 208(1)-208(4), respectively, via respective communication links 214(1)-214(4) (collectively referred to as communication links 214). In an example, the Vout command indicates a desired voltage regulator output voltage, Vout, to be provided to the processor core/chiplet. Communication links 218(1)-218(4) (collectively referred to as communication links 218) are coupled to communication links 214(1)-214(4), respectively, to provide the Vout commands from the processor cores/chiplets 220(1)-220(4), respectively, to the PEMC 210.

PEMC 210 is coupled to integrated voltage regulators 208(1)-208(4) via respective bidirectional communication links 216(1)-216(4) (collectively referred to as bidirectional communication links 216). Integrated voltage regulators 208(1)-208(4) send voltage regulator parameters to PEMC 210 via bidirectional communication links 216(1)-216(4), respectively, and also receive commands from PEMC 210 to adjust operational parameters of the integrated voltage regulators 208(1)-208(4). In some examples, the voltage regulator parameters sent from the integrated voltage regulators 208 to PEMC 210 include integrated voltage regulator current input, Iin, integrated voltage regulator current output, Iout, integrated voltage regulator voltage input, Vin, and integrated voltage regulator voltage output, Vout.

PEMC 210 is coupled to communication link 224 to communicate with other PEMCs. In some examples, PEMC 210 performs a global efficiency analysis based on the voltage regulation parameters received from integrated voltage regulators 208 and the Vout commands received from processor cores/chiplets 220. Based on the global efficiency analysis, PEMC 210 outputs a global Vin adjustment signal to global voltage regulator 202 via communication link 222. Based on the received global Vin adjustment signal, global voltage regulator 202 adjusts the global Vin voltage output on communication link 206 to integrated voltage regulators 208.

In some examples, PEMC 210 provides dynamic monitoring and control across a plurality of processor cores/chiplets 220 at the system/board/module level to adjust the global Vin and other integrated voltage regulator parameters for overall power efficiency optimization. In some examples, the operating conditions for the processor cores/chiplets 220 are continuously monitored by PEMC 210, and the most efficient global Vin and downstream voltage regulation parameters are dynamically and algorithmically adjusted across all processor cores/chiplets 220. Some examples allow for the dynamic control of the global Vin by PEMC 210, and monitoring by the PEMC 210 of the processor core/chiplet 220 input voltage (i.e., integrated voltage regulator 208 output voltage), input current drawn from each individual integrated voltage regulator 208 by each individual processor core/chiplet 220, along with integrated voltage regulator 208 input current and feedback information from each integrated voltage regulator 208. This information may be used by the PEMC 210 to determine the weighted efficiency of each integrated voltage regulator 208 at each processor core/chiplet 220, in real time. Each processor core/chiplet 220 may still dynamically adjust its own integrated voltage regulator 208 output voltage as needed (e.g., based on workload and silicon process via the Vout command using communication links 214), while the PEMC 210 may dynamically vary the global Vin (and optionally other integrated voltage regulator 208 operational parameters) for optimizing overall system conversion efficiency across the sum of all processor cores/chiplets 220 within the system.

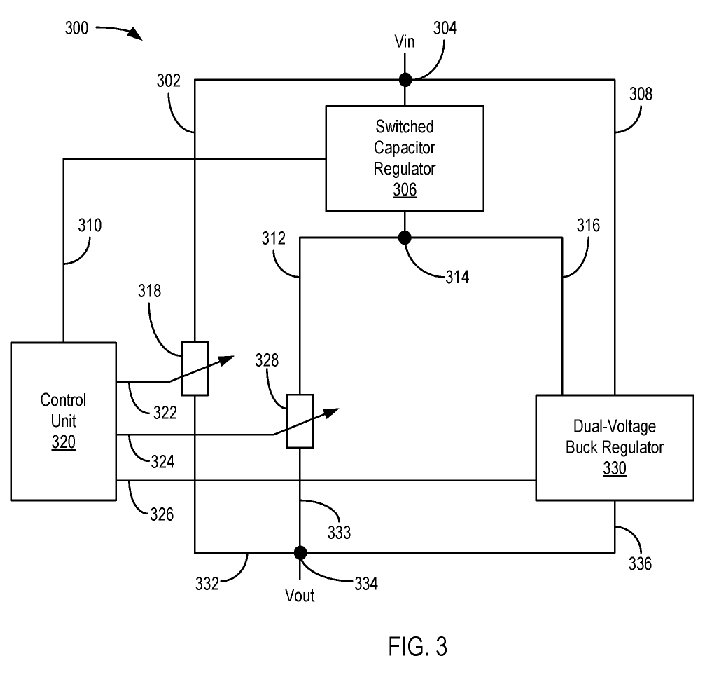

FIG. 3 sets forth an example multi-path voltage regulator 300 according to aspects of the present disclosure. Multi-path voltage regulator 300 is an example implementation of one of the integrated voltage regulators 208 (FIG. 2). Multi-path voltage regulator 300 includes switched capacitor regulator 306, linear regulators 318 and 328, control unit 320, and dual-voltage buck regulator 330. Control unit 320 may be implemented as a separate control unit within the multi-path voltage regulator 300 as shown in FIG. 3, or some or all of the functionality of control unit 320 may be implemented within PEMC 210 (FIG. 2). Control unit 320 is communicatively coupled to switched capacitor regulator 306 via communication link 310. Control unit 320 is communicatively coupled to linear regulator 318 via communication link 322. Control unit 320 is communicatively coupled to linear regulator 328 via communication link 324. Control unit 320 is communicatively coupled to dual-voltage buck regulator 330 via communication link 326.

Multi-path voltage regulator 300 receives an input voltage, Vin, via input node 304. In an example, the input voltage, Vin, may be the global Vin that is provided by global voltage regulator 202 (FIG. 2). Multi-path voltage regulator 300 outputs a regulated output voltage, Vout, via output node 334. In an example, the output voltage, Vout, may be output to a processor core/chiplet (e.g., one of the processor cores/chiplets 220). In some examples, switched capacitor regulator 306 regulates down the input voltage, Vin, by a particular ratio (e.g., 2:1). Thus, if the input voltage, Vin, is 2 volts, the output of switched capacitor regulator 306 at node 314 will be 1 volt. In some examples, the voltage regulation ratio used by switched capacitor regulator 306 may be a fixed ratio, or may be adjustable by control unit 320 via communication link 310.

Control unit 320 controls regulators 306, 318, 328, and 330 via the communication links 310, 322, 324, and 326, respectively, to select a voltage regulation path between nodes 304 and 334 that includes one or more of the regulators 306, 318, 328, and 330. A first voltage regulation path begins at input node 304; extends from input node 304 along conductive link 302 to linear regulator 318; and then extends from linear regulator 318 along conductive link 332 to output node 334. A second voltage regulation path begins at input node 304; extends from input node 304 to switched capacitor regulator 306; extends from an output node 314 of the switched capacitor regulator 306 along conductive link 312 to linear regulator 328; and extends along conductive link 333 from linear regulator 328 to output node 334.

In some examples, dual-voltage buck regulator 330 is selectively operated in one of three modes of operation that respectively correspond to third, fourth, and fifth voltage regulation paths. A first mode of operation of dual-voltage buck regulator 330 is a single input voltage mode that corresponds to a third voltage regulation path that begins at input node 304; extends from input node 304 to switched capacitor regulator 306; extends from the output node 314 of switched capacitor regulator 306 along conductive link 316 to dual-voltage buck regulator 330; and extends along conductive link 336 from dual-voltage buck regulator 330 to output node 334. A second mode of operation of dual-voltage buck regulator 330 is a single input voltage mode that corresponds to a fourth voltage regulation path that begins at input node 304; extends along conductive link 308 from input node 304 to dual-voltage buck regulator 330; and extends along conductive link 336 from dual-voltage buck regulator 330 to output node 334.

A third mode of operation of dual-voltage buck regulator 330 is a dual-voltage mode that corresponds to a fifth voltage regulation path that begins at input node 304. A first branch of the fifth voltage regulation path extends from input node 304 to switched capacitor regulator 306; and extends from the output node 314 of switched capacitor regulator 306 along conductive link 316 to dual-voltage buck regulator 330. A second branch of the fifth voltage regulation path extends along conductive link 308 from input node 304 to dual-voltage buck regulator 330. The fifth voltage regulation path then extends along conductive link 336 from dual-voltage buck regulator 330 to output node 334.

In some examples, control unit 320 continually monitors the input voltage, Vin, and a desired regulated output voltage, Vout, and identifies, based on an efficiency analysis, a most efficient voltage regulation path of multi-path voltage regulator 300 to produce that desired regulated output voltage, Vout, at output node 334. For example, the desired regulated output voltage may be specified by or determined from a processor core coupled to node 334. Every processor core in every chip may have a different workload and may need a different regulated output voltage, Vout. Depending on workload and chip-to-chip variations, the Vout requirements of the various processor cores may change over time. The multi-path voltage regulator 300 provides dynamic switching between the various voltage regulation paths depending on the current Vout demands.

As an example, assume that switched capacitor regulator 306 regulates the input voltage, Vin, down by a 2:1 ratio, so the output of switched capacitor regulator 306 at node 314 will be Vin/2. A switched capacitor regulator is typically efficient at dividing a global input voltage by integer multiples. If the desired regulated output voltage, Vout, is slightly less than Vin/2 (e.g., within 10% of Vin/2), then control unit 320 may select the second voltage regulation path that includes switched capacitor regulator 306 and linear regulator 328. However, if a processor core requires a regulated output voltage, Vout, of above Vin/2, this may eliminate the second and third voltage regulation paths from consideration as they may not be able to achieve that particular Vout. For example, a processor core may be operating in a turbo mode and may need to be driven by a higher than usual voltage (e.g., higher than Vin/2). In this case, the voltage regulation paths that are configured to regulate down from Vin directly (e.g., the first, fourth, and fifth) remain as options, and the most efficient one of these may be selected by the control unit 320.

In some examples, dual-voltage buck regulator 330 may use an inductor to buck down from a higher voltage to a lower voltage. The efficiency of this regulation may depend on the size of the inductor, the switching speed, as well as the magnitude of the delta-V (i.e., the difference between the larger input voltage and the smaller output voltage). For the linear regulators 318 and 328, each percentage that the voltage is regulated down may generally correspond to the percentage of loss in the linear regulator. For example, if a linear regulator is to regulate an input voltage down by 10%, this may cost the linear regulator 10% of its power, so it is operating at 90% efficiency. In contrast, a buck regulator may provide 95% efficiency to drop the input voltage by 10%. However, if the linear regulator is to regulate an input voltage down by 4%, for example, it may be able to do so at a 96% efficiency, so that it burns 4%, and has 96% remaining for the load. Thus, for smaller amounts of voltage regulation, the linear regulator may be more efficient than the buck regulator. If the desired regulated output voltage, Vout, is within a few percent of Vin/2, for example, the second voltage regulation path including linear regulator 328 may be selected by control unit 320.

As mentioned above, dual-voltage buck regulator 330 may include a dual-voltage mode, which corresponds to the fifth voltage regulation path. If the desired regulated output voltage, Vout, is between Vin and Vin/2, the dual-voltage buck regulator 330 in the dual-voltage mode may be able to accomplish this regulation more efficiently than regulating down based solely on the input voltage, Vin. If there is a large delta-V (e.g., bucking between Vin and ground), there may be a very rapid change in current, and a high switching speed may be used. In contrast, by making the delta-V smaller using the dual input voltages (e.g., Vin and Vin/2), switching may occur less frequently, and/or a smaller, more efficient inductor may be used.

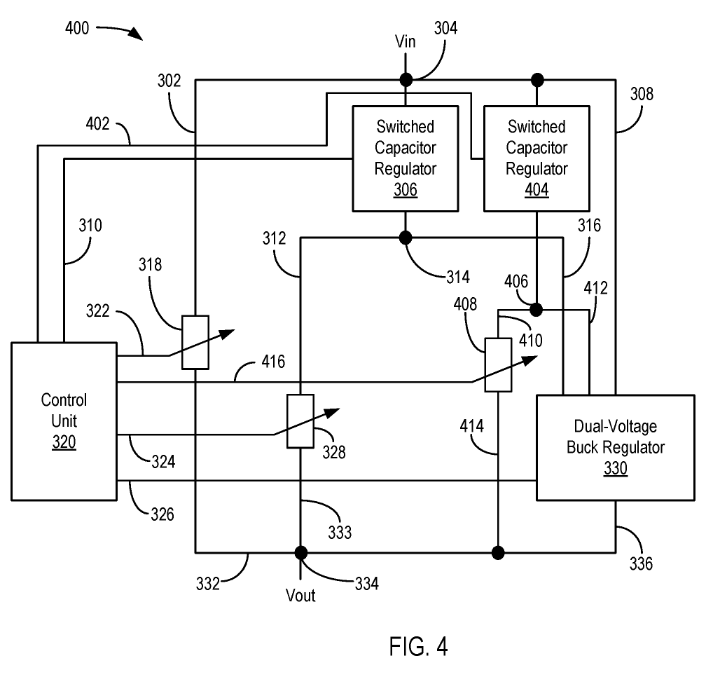

FIG. 4 sets forth another example multi-path voltage regulator 400 according to further aspects of the present disclosure. Multi-path voltage regulator 400 is an example implementation of one of the integrated voltage regulators 208 (FIG. 2). Multi-path voltage regulator 400 includes the same elements as multi-path voltage regulator 300 (FIG. 3), but also includes switched capacitor regulator 404 and linear regulator 408. Control unit 320 is communicatively coupled to switched capacitor regulator 404 via communication link 402. Control unit 320 is communicatively coupled to linear regulator 408 via communication link 416.

Multi-path voltage regulator 400 receives an input voltage, Vin, via input node 304. In an example, the input voltage, Vin, may be the global Vin that is provided by global voltage regulator 202 (FIG. 2). Multi-path voltage regulator 400 outputs a regulated output voltage, Vout, via output node 334. In an example, the output voltage, Vout, may be output to a processor core/chiplet (e.g., one of the processor cores/chiplets 220). In some examples, switched capacitor regulator 306 regulates down the input voltage, Vin, by a first ratio (e.g., 2:1), and switched capacitor regulator 404 regulates down the input voltage, Vin, by a second ratio (e.g., 3:1), which may be different than the first ratio. Thus, for example, if the input voltage, Vin, is 2.1 volts, the output of switched capacitor regulator 306 at node 314 will be 1.05 volts, and the output of switched capacitor regulator 404 at node 406 will be 0.7 volts. In some examples, the voltage regulation ratios used by switched capacitor regulators 306 and 404 may be fixed ratios, or may be adjustable by control unit 320 via communication links 310 and 402.

Control unit 320 controls regulators 306, 318, 328, 330, 404, and 408 via the communication links 310, 322, 324, 326, 402, and 416, respectively, to select a voltage regulation path between nodes 304 and 334 that includes one or more of the regulators 306, 318, 328, 330, 404, and 408. In addition to the five voltage regulation paths discussed above with reference to FIG. 3, multi-path voltage regulator 400 also provides sixth, seventh, eighth, and ninth voltage regulation paths. The sixth voltage regulation path begins at input node 304; extends from input node 304 to switched capacitor regulator 404; extends from an output node 406 of the switched capacitor regulator 404 along conductive link 410 to linear regulator 408; and extends along conductive link 414 from linear regulator 408 to output node 334.

In some examples, dual-voltage buck regulator 330 is selectively operated in one of six modes of operation that respectively correspond to third, fourth, fifth, seventh, eighth, and ninth voltage regulation paths. The first three modes of operation were discussed above with reference to FIG. 3. A fourth mode of operation of dual-voltage buck regulator 330 is a single input voltage mode that corresponds to a seventh voltage regulation path that begins at input node 304; extends from input node 304 to switched capacitor regulator 404; extends from the output node 406 of switched capacitor regulator 404 along conductive link 412 to dual-voltage buck regulator 330; and extends along conductive link 336 from dual-voltage buck regulator 330 to output node 334.

A fifth mode of operation of dual-voltage buck regulator 330 is a dual-voltage mode that corresponds to an eighth voltage regulation path that begins at input node 304. A first branch of the eighth voltage regulation path extends from input node 304 to switched capacitor regulator 306; and extends from the output node 314 of switched capacitor regulator 306 along conductive link 316 to dual-voltage buck regulator 330. A second branch of the eighth voltage regulation path extends from input node 304 to switched capacitor regulator 404; and extends from the output node 406 of switched capacitor regulator 404 along conductive link 412 to dual-voltage buck regulator 330. The eighth voltage regulation path then extends along conductive link 336 from dual-voltage buck regulator 330 to output node 334.

A sixth mode of operation of dual-voltage buck regulator 330 is a dual-voltage mode that corresponds to a ninth voltage regulation path that begins at input node 304. A first branch of the ninth voltage regulation path extends from input node 304 to switched capacitor regulator 404; and extends from the output node 406 of switched capacitor regulator 404 along conductive link 412 to dual-voltage buck regulator 330. A second branch of the ninth voltage regulation path extends along conductive link 308 from input node 304 to dual-voltage buck regulator 330. The ninth voltage regulation path then extends along conductive link 336 from dual-voltage buck regulator 330 to output node 334.

In some examples, control unit 320 continually monitors the input voltage, Vin, and a desired regulated output voltage, Vout, and identifies, based on an efficiency analysis, a most efficient voltage regulation path of multi-path voltage regulator 400 to produce that desired regulated output voltage, Vout, at output node 334. For example, the desired regulated output voltage may be specified by or determined from a processor core coupled to node 334. Every processor core in every chip may have a different workload and may need a different regulated output voltage, Vout. Depending on workload and chip-to-chip variations, the Vout requirements of the various processor cores may change over time. The multi-path voltage regulator 400 provides dynamic switching between the various voltage regulation paths depending on the current Vout demands.

As an example, assume that switched capacitor regulator 306 regulates the input voltage, Vin, down by a 2:1 ratio, so the output of switched capacitor regulator 306 at node 314 will be Vin/2, and further assume that switched capacitor regulator 404 regulates the input voltage, Vin, down by a 3:1 ratio, so the output of switched capacitor regulator 404 at node 406 will be Vin/3. If the input voltage, Vin, is 2.1 volts, and the eighth voltage regulation path is selected, then the dual-voltage buck regulator 330 may regulate between the 1.05 volts and the 0.7 volts output from regulators 306 and 404, respectively, which may be a common range at which some processors want to operate.

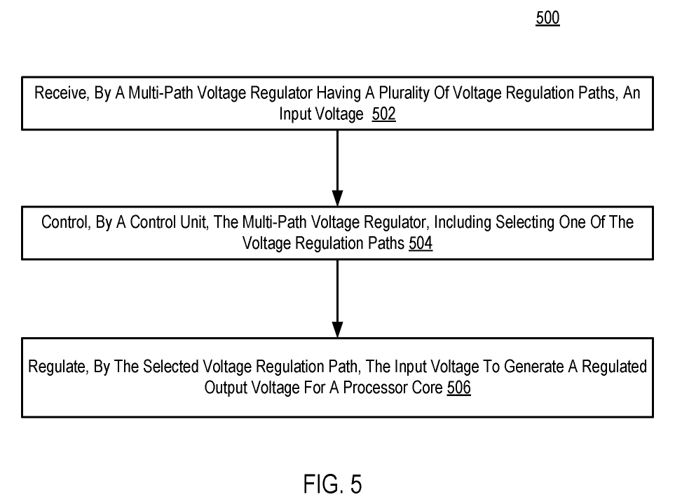

FIG. 5 sets forth a flowchart of an example method 500 for processor chip multi-path voltage regulation according to aspects of the present disclosure. In a particular embodiment, the method 500 is performed utilizing multi-path voltage regulator 300 (FIG. 3) or multi-path voltage regulator 400 (FIG. 4). The method 500 includes receiving 502, by a multi-path voltage regulator having a plurality of voltage regulation paths, an input voltage. The method 500 includes controlling 504, by a control unit, the multi-path voltage regulator, including selecting one of the voltage regulation paths. The method 500 includes regulating 506, by the selected voltage regulation path, the input voltage to generate a regulated output voltage for a processor core.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for processor chip multi-path voltage regulation, comprising:
receiving, by a multi-path voltage regulator having a plurality of voltage regulation paths, an input voltage;
controlling, by a control unit, the multi-path voltage regulator, including selecting one of the voltage regulation paths; and
regulating, by the selected voltage regulation path, the input voltage to generate a regulated output voltage for a processor core.

2. The method of claim 1, and further comprising:
performing, by the control unit, an efficiency analysis to identify a most efficient voltage regulation path from the plurality of voltage regulation paths, wherein selecting one of the voltage regulation paths is performed based on the efficiency analysis.

3. The method of claim 1, and further comprising:
receiving, by the control unit from the processor core, a command indicating a desired regulator output voltage, wherein selecting one of the voltage regulation paths is performed based on the command indicating the desired regulator output voltage.

4. The method of claim 1, wherein the plurality of voltage regulation paths includes a first path that includes a linear regulator and no other voltage regulators.

5. The method of claim 4, wherein the plurality of voltage regulation paths includes a second path that includes a combination of a switched capacitor regulator and a linear regulator.

6. The method of claim 5, wherein the plurality of voltage regulation paths includes a third path that includes a combination of the switched capacitor regulator and a buck regulator.

7. The method of claim 1, wherein the plurality of voltage regulation paths includes a path that includes a dual-voltage buck regulator to receive the input voltage and an intermediate regulated voltage that is generated based on the input voltage.

8. The method of claim 7, wherein the dual-voltage buck regulator is to generate the regulated output voltage for the processor core based on one or both of the input voltage and the intermediate regulated voltage.

9. The method of claim 1, wherein the plurality of voltage regulation paths includes a path that includes a dual-voltage buck regulator to receive a first intermediate regulated voltage that is generated based on the input voltage and a second intermediate regulated voltage that is generated based on the input voltage, and wherein the dual-voltage buck regulator is to generate the regulated output voltage for the processor core based on one or both of the first intermediate regulated voltage and the second intermediate regulated voltage.

10. An apparatus for processor chip multi-path voltage regulation, comprising:
a multi-path voltage regulator to receive an input voltage, wherein the multi-path voltage regulator includes a plurality of voltage regulation paths; and
a control unit to control the multi-path voltage regulator, including selecting one of the voltage regulation paths, wherein the selected voltage regulation path is to regulate the input voltage to generate a regulated output voltage for a processor core.

11. The apparatus of claim 10, wherein the control unit is to perform an efficiency analysis to identify a most efficient voltage regulation path from the plurality of voltage regulation paths, and wherein selecting one of the voltage regulation paths is performed based on the efficiency analysis.

12. The apparatus of claim 10, wherein the control unit is to receive from the processor core a command indicating a desired regulator output voltage, and wherein selecting one of the voltage regulation paths is performed based on the command indicating the desired regulator output voltage.

13. The apparatus of claim 10, wherein the plurality of voltage regulation paths includes a first path that includes a linear regulator and no other voltage regulators.

14. The apparatus of claim 13, wherein the plurality of voltage regulation paths includes a second path that includes a combination of a switched capacitor regulator and a linear regulator.

15. The apparatus of claim 14, wherein the plurality of voltage regulation paths includes a third path that includes a combination of the switched capacitor regulator and a buck regulator.

16. The apparatus of claim 10, wherein the plurality of voltage regulation paths includes a path that includes a dual-voltage buck regulator to receive the input voltage and an intermediate regulated voltage that is generated based on the input voltage.

17. The apparatus of claim 16, wherein the dual-voltage buck regulator is to generate the regulated output voltage for the processor core based on one or both of the input voltage and the intermediate regulated voltage.

18. The apparatus of claim 10, wherein the plurality of voltage regulation paths includes a path that includes a dual-voltage buck regulator to receive a first intermediate regulated voltage that is generated based on the input voltage and a second intermediate regulated voltage that is generated based on the input voltage, and wherein the dual-voltage buck regulator is to generate the regulated output voltage for the processor core based on one or both of the first intermediate regulated voltage and the second intermediate regulated voltage.

19. A system for processor chip multi-path voltage regulation, comprising:
a global voltage regulator to generate a global input voltage; and
a processor module coupled to the global voltage regulator, the processor module comprising:
one or more processor cores;
one or more multi-path voltage regulators to receive the global input voltage, wherein each of the one or more multi-path voltage regulators includes a plurality of voltage regulation paths; and
one or more control units to control the one or more multi-path voltage regulators, including selecting, for each of the one or more multi-path voltage regulators, one of the voltage regulation paths, wherein each selected voltage regulation path is to regulate the global input voltage to generate a regulated output voltage for one of the one or more processor cores.

20. The system of claim 19, wherein the one or more control units is to perform an efficiency analysis to identify, for each of the one or more multi-path voltage regulators, a most efficient voltage regulation path from the plurality of voltage regulation paths, and wherein selecting one of the voltage regulation paths is performed based on the efficiency analysis.
